(19) United States
(12) Patent Application Publication
(10) Pub. No.: US 2015/0160799 A1
(43) Pub. Date: Jun. 11, 2015

(54) METHOD AND APPARATUS FOR CONTROLLING CONTACT LIST OF ELECTRONIC DEVICE

(71) Applicant: Samsung Electronics Co., Ltd., Gyeonggi-do (KR)

(72) Inventors: Sungjoon Won, Gyeonggi-do (KR); Bonghak Choi, Gyeonggi-do (KR)

(21) Appl. No.: 14/567,973

(22) Filed: Dec. 11, 2014

(30) Foreign Application Priority Data
Dec. 11, 2013 (KR) 10-2013-0153613

(51) Int. Cl. G06F 3/0482; H04L 29/08; G06F 3/0484

(52) U.S. Cl. CPC G06F 3/0482; G06F 3/04842; H04L 67/10

(57) ABSTRACT

A method for controlling a contact list in an electronic device includes, when an event to be highlighted occurs, scheduling contact information related to the highlight event into a highlight area. The method further includes displaying the contact list comprising the highlight area containing the contact information related to the highlight event, and a normal area containing normal contact information. The contact information related to the event includes one or more contextual actions. When one of the contextual actions is selected, the method further includes executing the selected contextual action. An apparatus for controlling a contact list in an electronic device is also provided.

### CROSS-REFERENCE TO RELATED APPLICATION(S) AND CLAIM OF PRIORITY

The present application is related to and claims the benefit under 35 U.S.C. §119(a) of a Korean patent application filed on Dec. 11, 2013 in the Korean Intellectual Property Office and assigned Serial No. 10-2013-0153613, the entire disclosure of which is hereby incorporated by reference.

### TECHNICAL FIELD

The present disclosure relates to a method and apparatus for controlling a contact list of an electronic device.

### BACKGROUND

With a dramatic growth of digital technologies, a great variety of electronic devices, e.g., mobile communication terminals, smart phones, tablet PCs (Personal Computers), etc., allowing a personal information processing as well as a communication have been widely used. These electronic devices have the ability to offer various functions such as a call function, a message or email service function, a media (e.g., music or video) playback function, a scheduler function, an internet access function, a social network service (SNS) function, and a contact management function.

Particularly, using the contact management function, electronic devices may store contacts (e.g., phone numbers, email addresses, etc.) about personally or socially intimate persons in a phonebook. Normally the stored contacts may be arranged in alphabetical or lexicographical order in the form of list.

However, in case numerous contacts are stored in the phonebook of the electronic device, a user may often have difficulty in finding a desired contact. Also, since contacts stored in the phonebook merely show simple contact information, it is not easy for a user to be aware of a particular event related to a subscriber.

### SUMMARY

To address the above-discussed deficiencies, it is a primary object to provide a method and apparatus for offering notable contact information to a user by showing a specific event such as a subscriber-related schedule, a social network service, and a message in a highlight area.

For the above, the present disclosure allows the highlight area to be disposed distinguishably from a normal area at the execution of a contact application and also allows the highlight area to display a subscriber's name to be contacted, the content of a specific event, and a contextual action linked to a particular function related to a subscriber or event.

According to an embodiment of this disclosure, a method for controlling a contact list in an electronic device comprises, when an event occurs, defining contact information related to the event as contact information to be arranged in a highlight area; displaying the contact list containing the highlight area for arranging the contact information related to the event and a normal area for arranging normal contact information, wherein the contact information related to the event includes one or more contextual actions; and when one of the contextual actions is selected, executing the selected contextual action.

According to another embodiment of this disclosure, an apparatus for controlling a contact list in an electronic device comprises a display unit configured to display the contact list containing a highlight area and a normal area; and a control unit configured to define, when an event occurs, contact information related to the event as contact information to be arranged in the highlight area, and to control the display unit to distinguishably display the highlight area for arranging the contact information related to the event and the normal area for arranging normal contact information, wherein the contact information related to the event includes one or more contextual actions, and wherein when one of the contextual actions is selected, the control unit is further configured to execute the selected contextual action.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram illustrating an electronic device having a touch screen in accordance with embodiments of the present disclosure.

FIG. 2 is a view illustrating notable contact information to be arranged in a highlight area in accordance with embodiments of the present disclosure.

FIGS. 3A to 3F are screenshots illustrating a method for displaying a contact list divided into a highlight area and a normal area in accordance with embodiments of the present disclosure.

FIGS. 4A and 4B are flow diagrams illustrating a method for controlling a contact list in an electronic device in accordance with embodiments of the present disclosure.

FIG. 5 is a flow diagram illustrating a method for registering a specific event in a highlight region in accordance with an embodiment of the present disclosure.

FIGS. 6A to 6C are screenshots illustrating highlight types in accordance with embodiments of the present disclosure.

FIG. 7 is a flow diagram illustrating a method for determining a contextual action in accordance with embodiments of the present disclosure.

FIG. 8 is a view illustrating a method for determining a contextual action in accordance with embodiments of the present disclosure.

FIG. 9 is a flow diagram illustrating a method for determining priorities of highlight events and contextual actions in accordance with embodiments of the present disclosure.

FIGS. 10A and 10B are screenshots illustrating a method for determining priorities of highlight events and contextual actions in accordance with embodiments of the present disclosure.

FIGS. 11A to 11E are screenshots illustrating a method for controlling a contact list in an electronic device in accordance with embodiments of the present disclosure.

### DETAILED DESCRIPTION

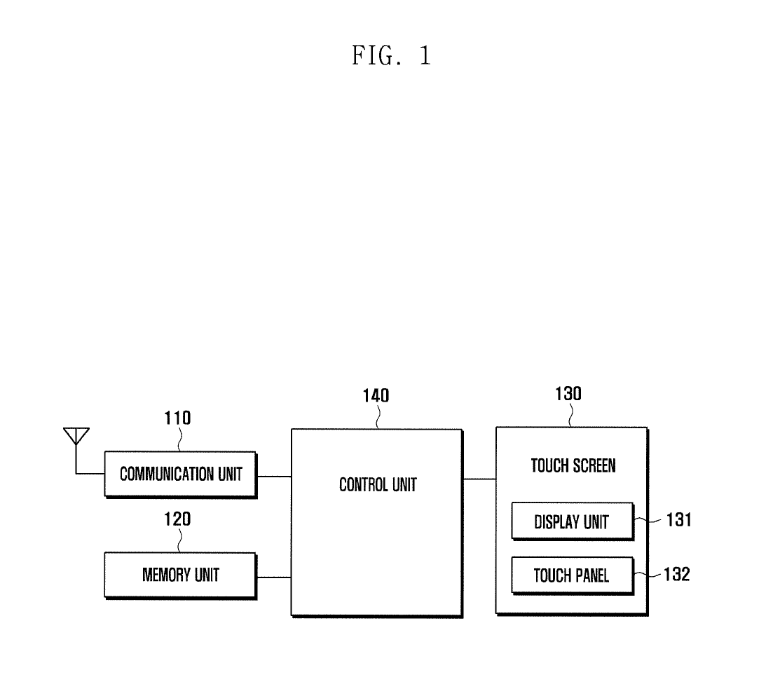

FIGS. 1 through 11E, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic devices. The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a signal” includes reference to one or more of such signals.

In this disclosure, “a contact list” may contain therein phonebook contacts and/or synchronization contacts synchronized with web servers (e.g., Google™, Facebook™, Twitter™, etc.) and such contacts may be arranged individually or in a group. The contact list may have “a contextual action”, which indicates a link to a particular function related to each contact and may be represented as a specific item (e.g., an icon, a soft button, etc.) for triggering a message transmission action, a conference call action, an email transmission action, and the like. Using such an item, a user can easily use a desired function related to a specific contact. Additionally, the contact list may be divided into “a highlight area” and “a normal area”. Contact information arranged in the highlight area may be removed in response to the execution of a contact function, whereas contact information arranged in the normal area and registered by a user may still remain after a contact function is executed. The highlight area and the normal area may be displayed distinguishably from each other by means of color, shade, or any other graphical effect.

In this disclosure, the highlight area indicates a specific area used to display notable contact information, i.e., contact information being worthy of a user's notice, when a contact application or a call application is executed. Contact information may include, but not limited to, a subscriber's name, the content of an event, and a contextual action. Contact information to be displayed in the highlight area may include, for example, contact information about a subscriber having an approaching birthday, contact information about a subscriber who sent a missed call or a new message, contact information about an upcoming schedule, contact information about a new-created mutual relationship, contact information about the unknown who frequently tried contact, contact information about a reminder preset by a user, a group associated with an updated user, and contact information having an updated profile. Additionally, contact information may have priority determined according to importance or urgency, and contact information selected from a contact list and displayed in the highlight area may be arranged in the order of priority. Meanwhile, the normal area indicates an area used to display contact information selected from a contact list and registered by a user. When a contact list is displayed, the normal area may be disposed below the highlight area.

An electronic device according to the present disclosure may include a mobile communication terminal, a smart phone, a tablet PC (Personal Computer), a handheld PC, a laptop PC, a notebook PC, a PDA (Personal Digital Assistant), a PMP (Portable Multimedia Player), a wearable device, and other various equivalents.

FIG. 1 is a block diagram illustrating an electronic device having a touch screen in accordance with embodiments of the present disclosure.

Referring to FIG. 1, the electronic device can include, but not limited to, a communication unit 110, a memory unit 120, a touch screen 130, and a control unit 140.

The communication unit 110 can perform a voice call, a video call, or a data communication with any external device through a network. The communication unit 110 can include an RF (radio frequency) transmitter that up-converts the frequency of an outgoing signal and then amplifies the signal, an RF receiver that amplifies with low-noise an incoming signal and down-converts the frequency of the signal, and the like. Also, the communication unit 110 can include a modulator and a demodulator, which are adapted for CDMA (Code Division Multiple Access), WCDMA (Wideband CDMA), LTE (Long Term Evolution), Wi-Fi (Wireless Fidelity), WiBro (Wireless Broadband internet), Bluetooth, NFC (Near Field Communication), and the like. The communication unit 110 can include a mobile communication module, an internet communication module, and/or a short-range communication module.

The memory unit 120 can include a program memory for storing therein an operating program of the electronic device, and a data memory for storing therein data created during the execution of such a program.

The touch screen 130 can include a display unit 131 and a touch panel 132 in an integrated form. The display unit 131 can display thereon a variety of screens associated with the operation of the electronic device under the control of the control unit 140. The display unit 131 can be formed of LCD (Liquid Crystal Display), OLED (Organic Light Emitting Diode), AMOLED (Active Matrix OLED), flexible display, bended display, 3D (three-dimensional) display, or the like. Additionally, the display unit 131 can be realized in a flexible, transparent or wearable form. The touch panel 132 can have an integrated form of a finger touch panel for sensing a finger gesture and a pen touch panel for sensing a pen gesture.

Particularly, in embodiments of this disclosure, the display unit 131 can display thereon a contact list divided into a highlight area and a normal area under the control of the control unit 140. Also, the display unit 131 can display a contextual action in the contact list. The contextual action can be represented as a specific item (e.g., an icon, a soft button, etc.) for triggering a message transmission action, a conference call action, an email transmission action, etc. in connection with a particular contact function.

The control unit 140 controls an overall operation of the electronic device and a signal flow between internal elements of the electronic device. Additionally, the control unit 140 performs a data processing function and controls power supply from a battery to such elements.

Particularly, in embodiments of this disclosure, the control unit 140 can control the display unit 131 to display the contact list such that contact information in the highlight area is distinguished from contact information in the normal area. When a gesture is detected from the highlight area through the touch panel 132, the control unit 140 can control the contact list of the highlight area to be extendedly displayed on the display unit 131. Also, when a suitable touch input is detected from a contextual action item arranged in the contact list through the touch panel 132, the control unit 140 can perform a particular function corresponding to the touched item. And also, when the occurrence of a new event is detected, the control unit 140 can control the display unit 131 to display the contact list arranged again according to priority.

Although not illustrated in the drawings, the electronic device can further essentially or optionally have any other element such as a GPS (Global Positioning System) module, an audio processing unit having a microphone and a speaker, an input unit for supporting an input mechanism based on a hard key, and the like.

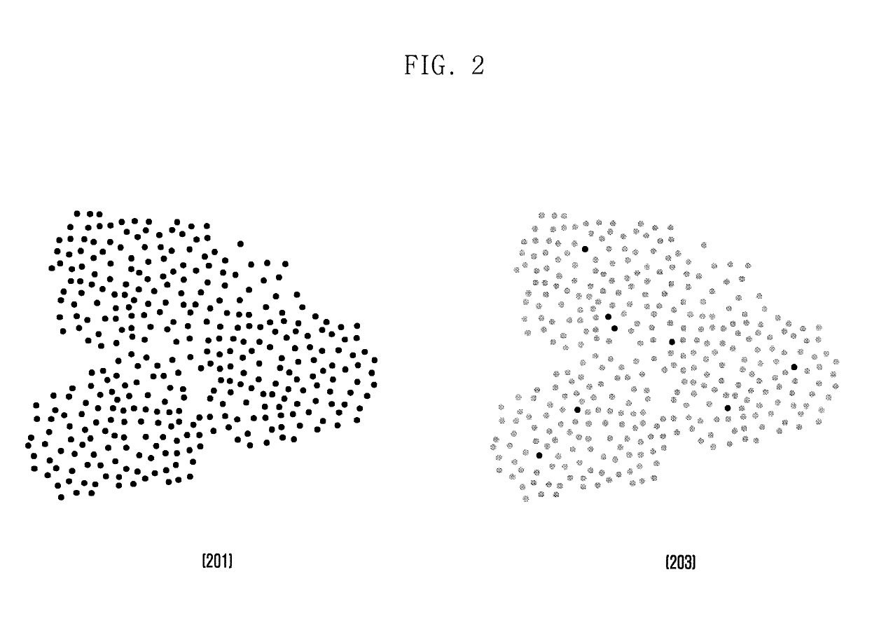

FIG. 2 is a view illustrating notable contact information to be arranged in a highlight area in accordance with embodiments of the present disclosure.

Referring to FIG. 2, the contact list can have in general several hundred or several thousand user entries as indicated by a reference numeral 201. However, in this case, a user can have much difficulty in finding notable contacts in the contact list. It is therefore desirable for the control unit 140 to give a highlight to specific contact information as indicated by a reference numeral 203 and to automatically notify such highlighted information to a user.

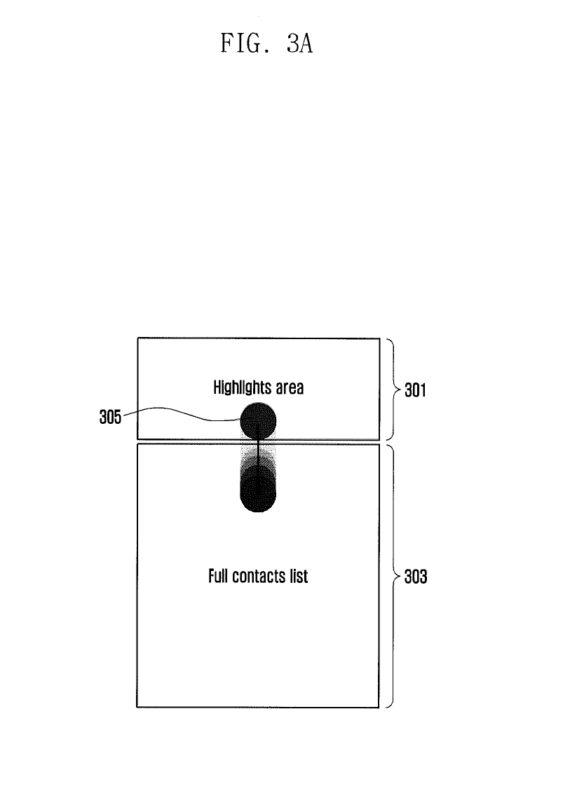

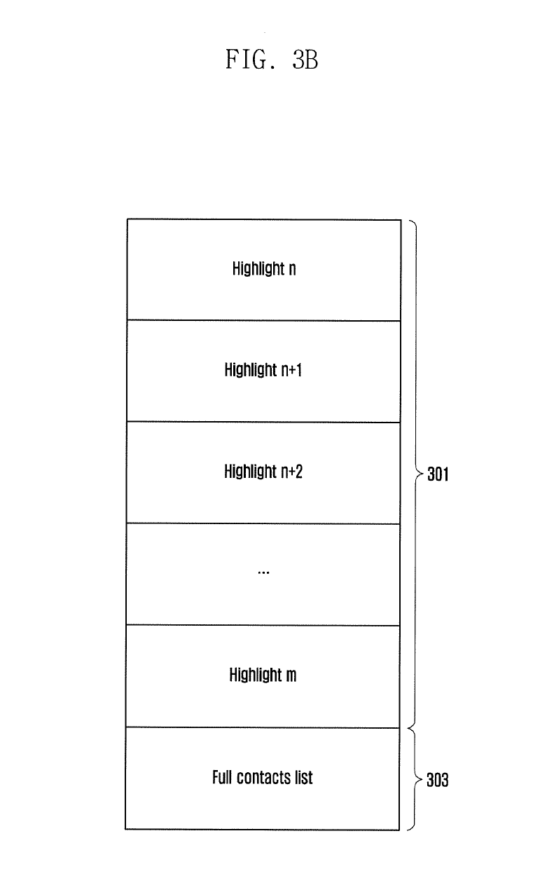

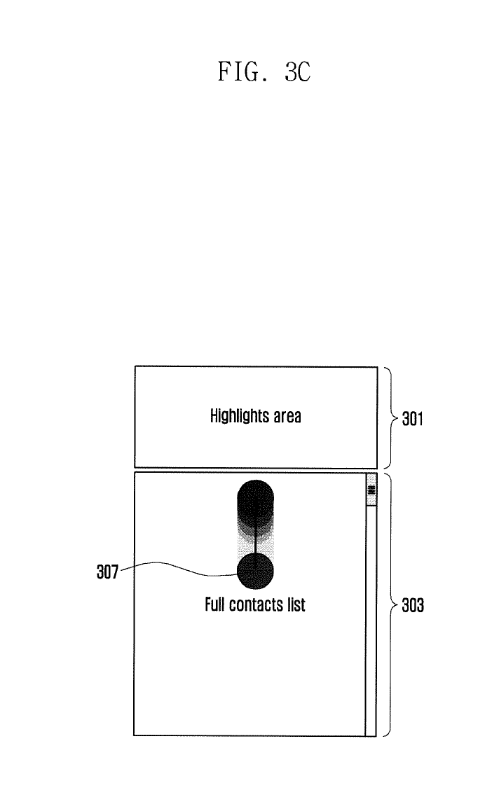

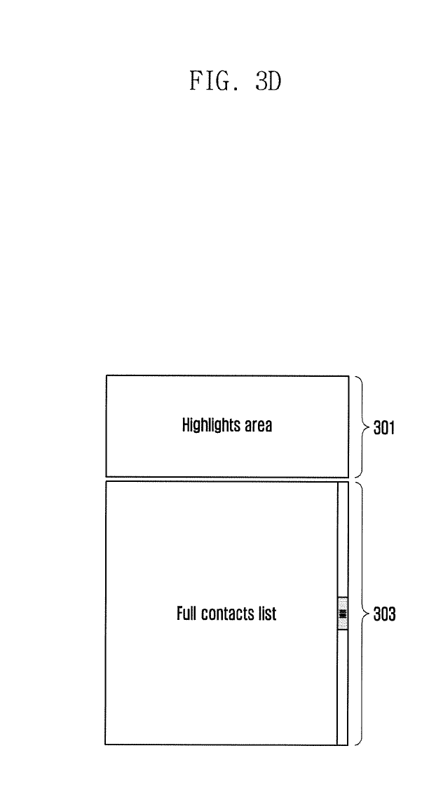

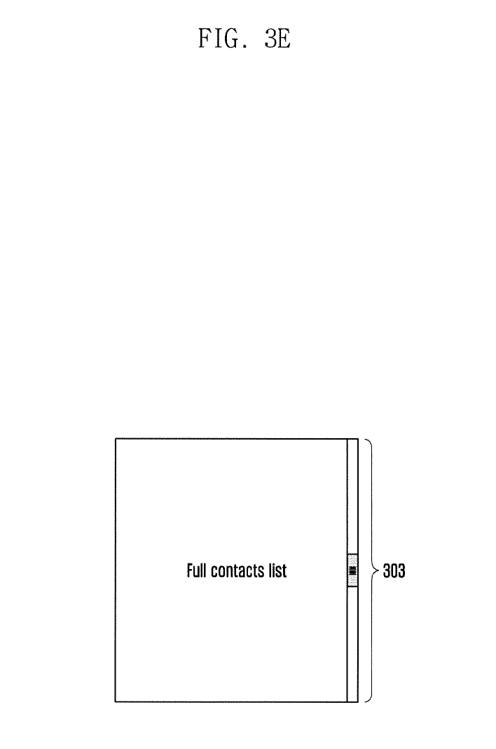

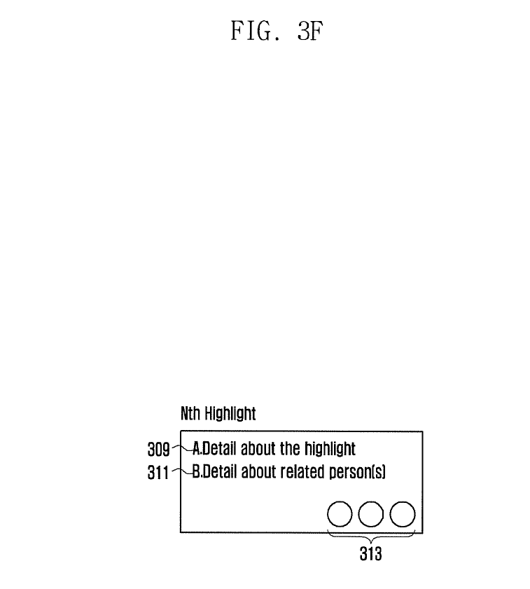

FIGS. 3A to 3F are screenshots illustrating a method for displaying a contact list divided into a highlight area and a normal area in accordance with embodiments of the present disclosure.

Referring to FIG. 3A, the control unit 140 can control the display unit 131 to display a contact list. The contact list can contain therein phonebook contacts and/or synchronization contacts synchronized with web servers. Additionally, the contact list can be divided into a highlight area 301 and a normal area 303. The highlight area indicates an area used to display notable contact information, i.e., contact information being worthy of a user's notice, and the normal area indicates an area used to display contact information registered by a user in the contact list. If the number of contact information to be displayed in the highlight area is m, the number of contact information displayed initially can be n (e.g., one, n is equal to or smaller than m). Although it will be described hereinafter that only one contact information is displayed initially when a contact application or a call application is executed, this is exemplary only and not to be considered as a limitation of this disclosure. As will be discussed below, when a gesture is detected from the highlight area, the highlight area can be extended and hence every contact information m in number can be displayed together in the extended highlight area.

The control unit 140 can arrange contact information related to an occurring event, e.g., a subscriber's birthday, an unconfirmed communication event (e.g., a missed call), a schedule reminder event, etc., in the highlight area and also arrange contact information (e.g., phonebook contacts in the electronic device, synchronization contacts synchronized with web servers) registered by a user in the normal area. As discussed above, the highlight area and the normal area can be displayed distinguishably from each other by means of color, shade, or any other graphical effect such that a user can perceive intuitively contact information displayed in the highlight area.

When a gesture is detected from the highlight area as indicated by a reference numeral 305 in FIG. 3A, the control unit 140 can control the display unit 131 to display extendedly, i.e., in a full mode, the contact list of the highlight area. Specifically, each of the highlight area and the normal area can be formed of a single layer, and the control unit 140 can control the display unit 131 to overlay hidden contact information of the highlight area on the normal area in response to a detection of a gesture from the highlight area. This separately layered structure is exemplary only and not to be considered as a limitation of this disclosure. A gesture for causing an extended display of the contact list in a full mode can be a touch-based gesture such as a drag or a flick, which is not considered as a limitation of this disclosure. If the number of contact information to be displayed in the highlight area is m, and if contact information of n in number is displayed initially in the highlight area, the control unit 140 can display contact information of m in number in the extended highlight area as shown in FIG. 3B. The contact list of the normal area can be disposed below the extended highlight area.

Meanwhile, when a gesture is detected from the normal area as indicated by a reference numeral 307 in FIG. 3C, the control unit 140 can fix the highlight area and also display the contact list of the normal area as shown in FIG. 3D. This gesture can be a touch-based gesture such as a drag or a flick, which is not considered as a limitation of this disclosure. The contact list of the normal area displayed after this gesture can be in a scrollable state. In an alternative embodiment, when a gesture is detected from the normal area as shown in FIG. 3C, the highlight area can be removed as shown in FIG. 3E.

As shown in FIG. 3F, contact information forming the contact list can include a highlight event type as indicated by a reference numeral 309, event-related contact information as indicated by a reference numeral 311, and contextual actions related to events and contact information as indicated by a reference numeral 313. The contextual action is a specific item assigned to perform a particular function related to contact information and can include a message transmission action, a conference call action, an email transmission action, and the like. Also, the contextual action can be determined according to a highlight event, contact information, a user device status, or a combination thereof.

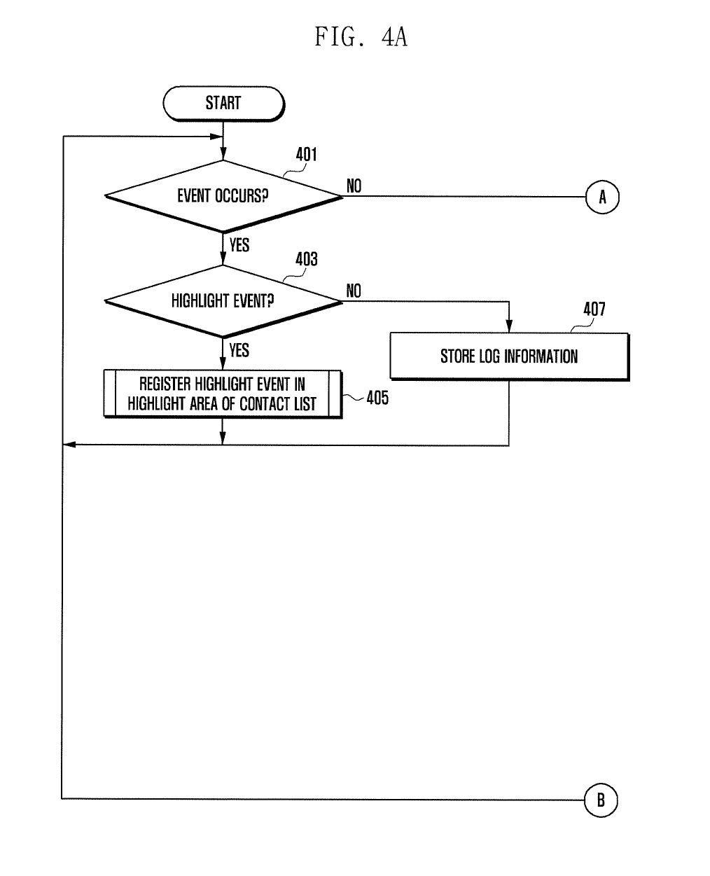

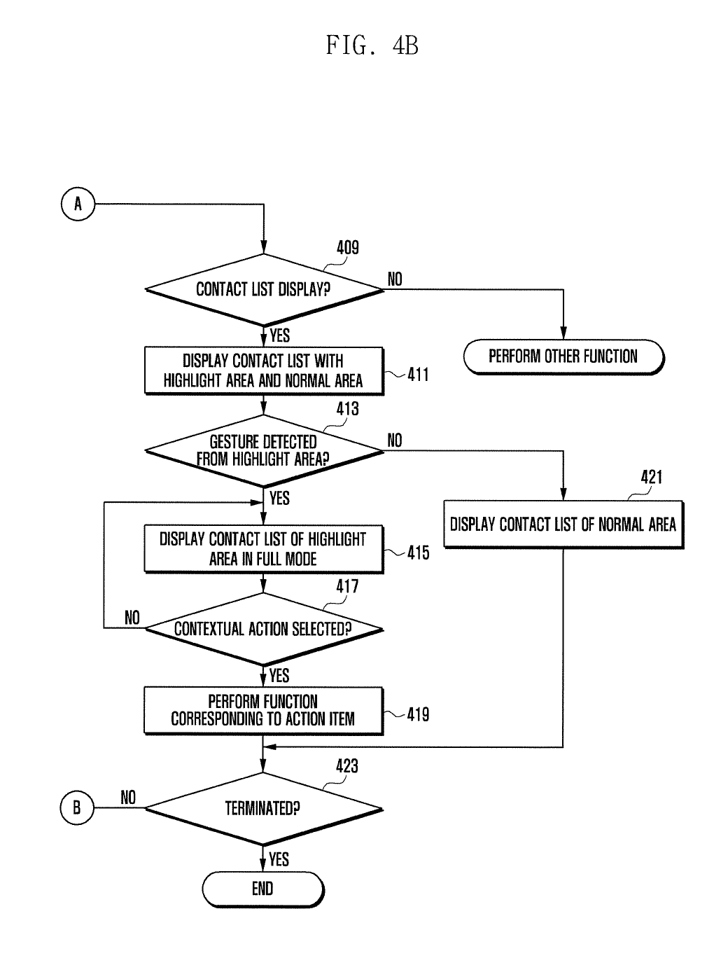

FIGS. 4A and 4B are flow diagrams illustrating a method for controlling a contact list in an electronic device in accordance with embodiments of the present disclosure.

Referring to FIGS. 4A and 4B, the control unit 140 can detect at step 401 whether an event occurs. This event can include, for example, a birthday, a call, a message, a social network, service, a missed call, a schedule reminder, and the like.

When the occurrence of an event is detected at step 401, the control unit 140 can determine at step 403 whether the occurring event is a highlight event. This highlight event can include, for example, contact information about an approaching birthday, contact information about a missed call or a new message, contact information about an upcoming schedule, contact information about a received invitation message, contact information about a new-created mutual relationship, contact information about a frequent unknown contact, contact information about a reminder preset by a user, a group associated with an updated user, and contact information having an updated profile. The above-mentioned nine highlight events are exemplary only and not to be considered as a limitation of this disclosure.

If a highlight event is detected at step 403, the control unit 140 can register the highlight event in the highlight area of the contact list at step 405.

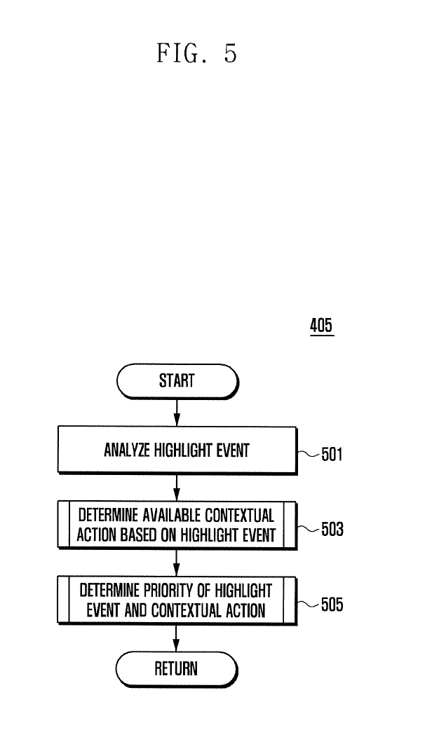

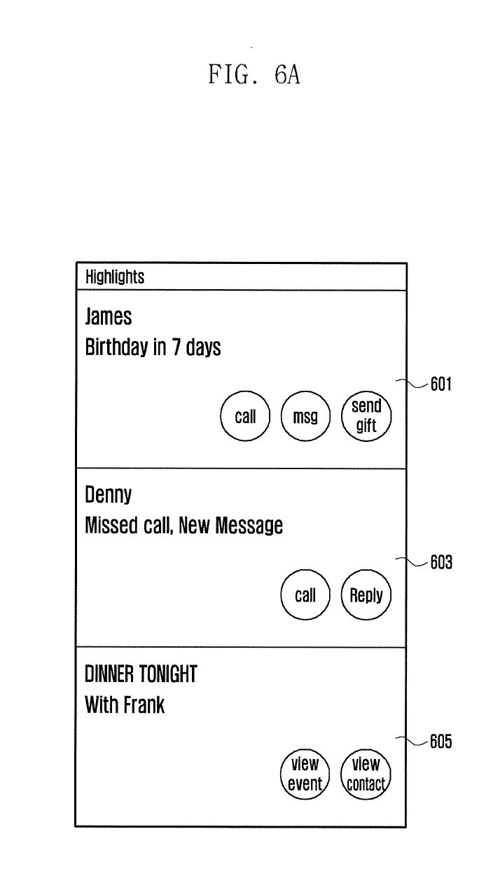

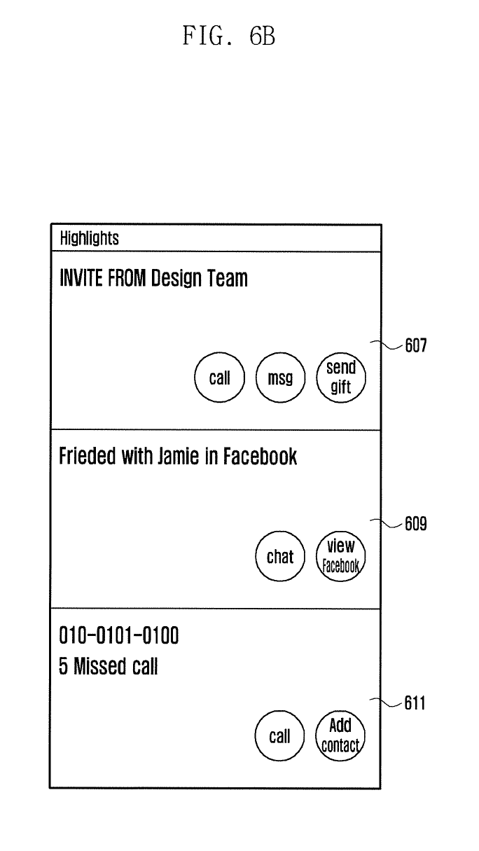

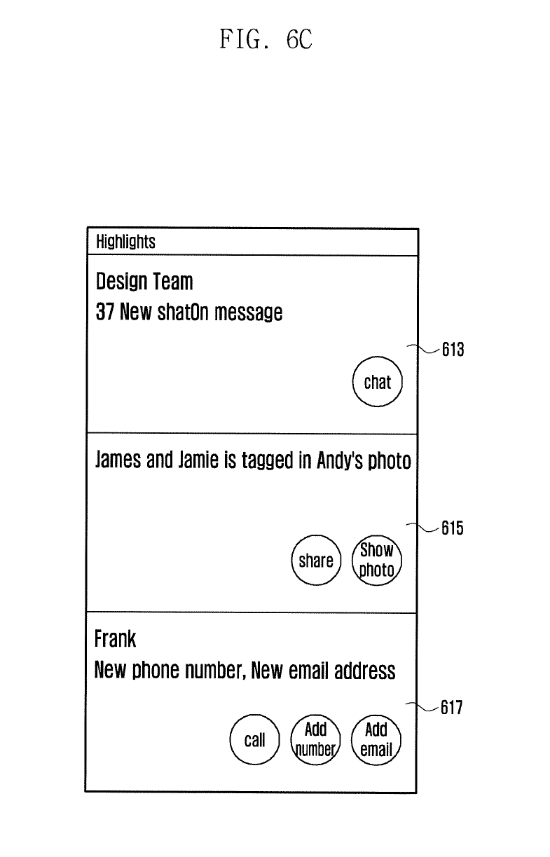

Details of step 405 will be described hereinafter with reference to FIGS. 5 and 6A to 6C. FIG. 5 is a flow diagram illustrating a method for registering a specific event in a highlight region in accordance with an embodiment of the present disclosure. FIGS. 6A to 6C are screenshots illustrating highlight types in accordance with embodiments of the present disclosure.

Referring to FIGS. 5 and 6A to 6C, the control unit 140 can analyze the highlight event at step 501.

Specifically, nine events allowed to be displayed in the highlight area are as follows. First, the control unit 140 can control displaying contact information about an approaching birthday in the highlight area as indicated by a reference numeral 601 in FIG. 6A. In this case, the control unit 140 can obtain birthday data from a birthday field of a phonebook stored in the electronic device or from synchronized contacts linked to web servers (e.g., ChatOn™ or messenger service, Samsung account or other account service, Facebook™, Twitter™, etc.), determine a subscriber having an approaching birthday, and display related information in the highlight area. The date notation format can be varied according to settings of a web server. In some cases, a subscriber's birthday can be obtained in a way of querying birthday data to any third party or external data provider from Samsung contact system or a related framework or in a way of providing Samsung contact system with Samsung API (Application Program Interface) allowing a related provider to enter data.

Additionally, the control unit 140 can display contact information in the highlight area, based on different date criteria for subscribers. Specifically, if any contact information is set to favorite contacts, the control unit 140 can control displaying such contact information in the highlight area earlier than a specific event date. For example, if a normal subscriber's birthday is displayed in the highlight area one day before the birthday, the control unit 140 can display a favorite contact subscriber's birthday in the highlight area one week before the birthday in order to notify an important subscriber's event to a user. Also, the control unit 140 can control the display unit 131 to display contextual action items for triggering related functions such as a call, sending a birthday message, and sending a gift. In another example, the control unit 140 can analyze a distance between a user's residence location and a subscriber's residence location and then, if the analyzed distance is longer than a given value, control displaying a subscriber's birthday in the highlight area earlier than a specific event date. For example, since a gift-sending action has to consider physical requirements (e.g., time required for carefully choosing a desired gift, time required for delivering the selected gift, intervention of a rest day, etc.), a display in the highlight area can start earlier than a specific event date in case a subscriber's residence location is distant.

Second, the control unit 140 can control displaying contact information about a missed call or a new message in the highlight area as indicated by a reference numeral 603 in FIG. 6A. The control unit 140 can include a framework such as a communication logger, which can monitor and manage, for each subscriber, a phone call, a text message, an email, a ChatON message, a ChatON voice call, a ChatON video call, details about third party or external communication application (e.g., Facebook™, Skype™, KakaoTalk™) as shown in Table 1.

TABLE 1

| Phone call | Text message | Email | |
|---|---|---|---|
| ChatON | ChatON | ChatON | Details about third party or |
| message | voice | video | external communication applica- |
| | call | call | tion (e.g., Facebook, Skype, |
| | | | KakaoTalk) |

Additionally, recently received items, received but non-read items and counts thereof, and/or received and read items with no follow-up action (e.g., reply) and counts thereof can be displayed for each subscriber in the highlight area. Also, contextual action items such as calling or replying can be further displayed. If there is a dialog list with a subscriber when a reply action item is selected, the control unit 140 can control displaying a dialog window with the subscriber.

Third, the control unit 140 can control displaying contact information about an upcoming schedule as indicated by a reference numeral 605 in FIG. 6A. The control unit 140 can display schedules within the given number of days (e.g., seven days) in the highlight area through a calendar database, if necessary, together with an attendance list for each schedule. In case there are several upcoming schedules, they can be arranged from the nearest schedule. Additionally, the control unit 140 can analyze each subscriber's schedule in a way of querying subscriber's inviting or attending events to any third party or external data provider from Samsung contact system or a related framework or in a way of providing Samsung contact system with Samsung API (Application Program Interface) allowing a related provider to enter data. Also, the control unit 140 can display reminder data predetermined for each event in the highlight area one day or one week before the event. And also, contextual action items such as a detail view of an event or a view of a contact can be further displayed. In this disclosure, a setting time for displaying contact information related to events in the highlight area can be a default value but varied by a user.

Fourth, the control unit 140 can control displaying contact information about a received event invitation message as indicated by a reference numeral 607 in FIG. 6B. Specifically, if an invitation message is received from a subscriber as shown in Table 2, the control unit 140 can display the received invitation message and contact information in the highlight area. Additionally, contextual action items such as a detail view of contact information, a detail view of an event, or a reply can be further displayed. In case a reply item is selected, a function to reply whether to attend an invitation event (e.g., Attend, Do not attend, Pending, etc.) can be provided.

TABLE 2

| Criteria for display | |
|---|---|
| in highlights | Follow-up action |
| Show contact who | * Providing a detail view entrance function of such a |
| invited user | contact |
| to an event | * Providing a detail view entrance function of such a |
| | event |
| | * Providing a function to reply an invitation (Attend, |
| | Do not attend, Pending, etc.) |

For example, an invitation through Google calendar, B2B supporting a calendar invitation (i.e., a calendar invitation for B2B customer who plans a meeting), and the like are possible.

Fifth, the control unit 140 can display contact information (e.g., friend and/or group) about a new-created mutual relationship in the highlight area as indicated by a reference numeral 609 in FIG. 6B. Specifically, the control unit 140 can display contact information about a mutual relationship newly created through a web server (e.g., ChatON™ or messenger service, Facebook™, Twitter™, etc.) in the highlight area. For example, when a mutual relationship is created between a user and a subscriber based on Samsung account (two-way agreement) or by offering Facebook and third party/external service, contact information can be displayed in the highlight area.

Sixth, the control unit 140 can display contact information in the highlight area in case there are several missed call from an unknown number or a number stored in the phonebook as indicated by a reference numeral 611 in FIG. 6B. Specifically, if there are several missed call (e.g., more than n-times) from unknown contact information (e.g., a phone number, an email address, a messenger ID, etc.) not stored in the electronic device, or if there are several missed call from a stored contact, related contact information can be displayed in the highlight area. Also, contextual action item such as a call or adding a contact can be further displayed.

Seventh, the control unit 140 can display contact information about a reminder predetermined by a user in the highlight area. Specifically, based on criteria shown in Table 3, the control unit 140 can display contact information in the highlight area. Also, related contextual action items can be further displayed.

TABLE 3

| Criteria for display | |
|---|---|
| in highlights | Follow-up action |
| Reject an incoming | Providing a detail view entrance function of such |
| call and call back | a contact |
| later | Function to call back to an incoming call number |
| | In case there are two or more sender's numbers, |
| | function to call to a number other than a received |
| | number |
| Reply later to a | Providing a detail view entrance function of such |
| received message | a contact |
| (text, ChatON, third | Function to reply to a received message (if select- |
| party messenger) | ed, move to a view of the last message) |
| Reply later to a | Providing a detail view entrance function of such |
| received email | a contact |
| | Function to reply to a received email (if selected, |
| | move to a view of the last message) |

Eighth, the control unit 140 can display a group having any update in the highlight area. In this disclosure, although groups are classified into a sustainable group and a temporary group, this is exemplary only and not to be considered as a limitation of this disclosure.

Specifically, a sustainable group can include a group created in a phonebook application, a ChatON or messenger service, or any third party or external service by a user and/or a user group according to group types as shown in Table 4. If a new subscriber is added to a group to which a subscriber stored in the phonebook application, the ChatON or messenger service, or the electronic device belongs, group information and action items such as a detail view of new contact information (e.g., a phone number, an email address, etc.) or a detail view of group information can be offered. In case a subscriber stored in the electronic device invites a user to a new group, related contact information and group information can be offered and also action items such as a reply to an invitation (e.g., join or discard) or a detail view of group information can be offered. If a group name is changed, action items such as a detail view of group information can be offered. If a group is removed, this can be displayed in the highlight area. If any update occurs in connection with a group, follow-up action (e.g., a detail view of group information, a view of updated information) items related to such update can be offered. If a new message is received from a group as indicated by a reference numeral 613 in FIG. 6C, an action item for reading the received message can be offered. If a new contact is added to a group, action items such as a detail view of new contact information or a detail view of group information can be offered.

TABLE 4

| | Criteria for display in | |
|---|---|---|
| Group type | highlights | Follow-up action |
| Group created | New member added to | Showing a new member and |
| in a contact | a group | providing contact means |
| application | | Detail view of such a group |
| by a user | When a known contact | Providing information about |
| | invites me to a new | a person, who invited me, |
| | group | and group |
| | | Providing a function to |
| | | replay to an invitation |
| | | (join, discard, etc.) |
| | | Detail view of such a group |
| | Group name changed | Detail view of such a group |
| | Group removed | None (only discard, which |
| | | also exists as a basic |
| | | function for all highlights) |
| User group | When a new message is | Reading a new message |
| in ChatON | received from such a | |
| | group window | |
| | New member added to a | Showing a new member and |
| | group | providing contact means |
| | | Detail view of such a group |
| | When a known contact | Providing information about |
| | invites me to a new | a person, who invited me, |
| | group | and group |
| | | Providing a function to |
| | | replay to an invitation |
| | | (join, discard, etc.) |
| | | Detail view of such a group |
| | Group name changed | Detail view of such a group |
| | Group removed | None (only discard, which |
| | | also exists as a basic |
| | | function for all highlights) |
| User group in | When a group-related | Providing a follow-up action |
| third party | attribute is updated | related to update |
| or external | | |
| service | | |

Additionally, a temporary group can be temporarily displayed in the highlight area when any event temporarily occurs (e.g., in case contact information about one or more persons is associated with tag, or a missed call, etc.). Specifically, as shown in Table 5, if two or more subscribers stored in the electronic device are tagged to a photo, the control unit 140 can show contact information and also offer action items such as a photo sharing, a photo view, or addition of contact to a group. For example, if James and Jamie are tagged to Andy's photo as indicated by a reference numeral 615 in FIG. 6C, a tag event and contact information can be displayed in the highlight area and contextual action items such as a photo sharing or a photo view can be further displayed.

TABLE 5

| | Criteria for display in | |
|---|---|---|
| Group type | highlights | Follow-up action |
| Temporary | A photo is taken with | Showing a member and |
| | 2 or more people from | providing a photo |
| | my cont acts tagged | sharing function |
| | | Providing a function |
| | | to view a photo |
| | | Providing a function |
| | | to add a member to a |
| | | group |
| | A new ChatON conversa- | Providing a function |
| | tion from 2 more people | to enter a conversation |
| | not belonging to a group | |

Ninth, the control unit 140 can display contact information in the highlight area when contact information is updated as indicated by a reference numeral 617 in FIG. 6C. Specifically, based on criteria shown in Table 6, contact information can be displayed in the highlight area. Also, related contextual action items can be further displayed.

TABLE 6

| Criteria for display | |
|---|---|
| in highlights | Follow-up action |
| New phone | Providing a detail view entrance function of such a |
| number | contact |
| | Providing a function to call or send a text message |
| | to a new number |
| New email | Providing a detail view entrance function of such a |
| address | contact |
| | Providing a function to send an email to a new |
| | address |
| New Samsung | Providing a detail view entrance function of such a |
| account | contact |
| | Providing respective Samsung service functions |
| | (e.g., ChatON) for interacting with an opponent |
| | in connection with Samsung account |
| New linked | Providing a detail view entrance function of such a |
| account | contact |
| | Providing a detail view entrance function of a new |
| | linked account |
| New photo | Providing a detail view entrance function of such a |
| ID | contact |
| | Providing a function to view a new photo ID |

As discussed hereinbefore, executable actions are found for each highlight event according to the highlight event analysis at step 501. Also, priorities of contextual actions can be determined for each highlight event. Namely, the control unit 140 can determine a contextual action according to the highlight event at step 503.

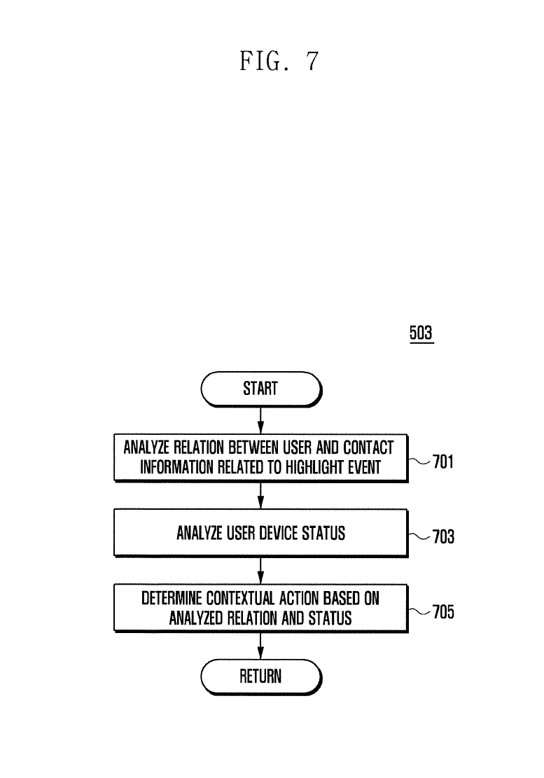

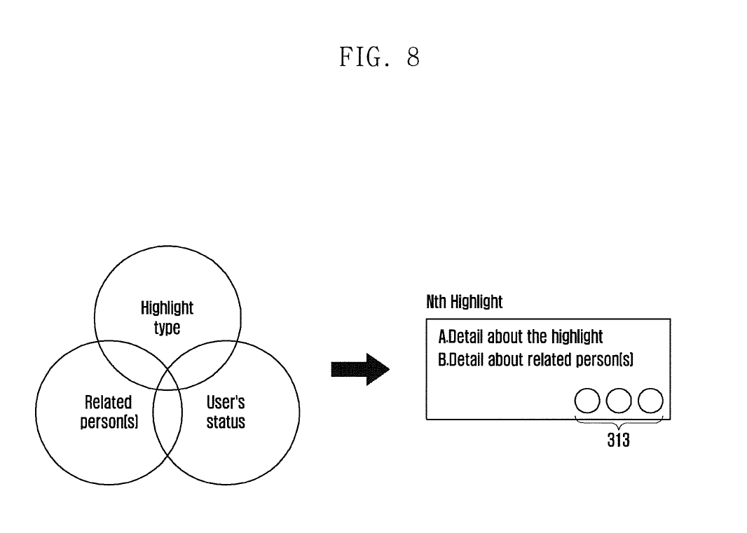

Now, step 503 in FIG. 5 will be described in detail with reference to FIGS. 7 and 8. FIG. 7 is a flow diagram illustrating a method for determining a contextual action in accordance with embodiments of the present disclosure. FIG. 8 is a view illustrating a method for determining a contextual action in accordance with embodiments of the present disclosure.

Action items can be varied according to highlight events. Specifically, action items can be selectively displayed depending on a highlight event, a relation between a user and contact information in connection with a highlight event, or a status of a user device.

Referring to FIGS. 7 and 8, at step 701, the control unit 140 can analyze a relation between a user and a subscriber in connection with a highlight event. Specifically, depending on contactable means for each subscriber, a subscriber's current status, a relation between a user and a subscriber (e.g., a favorite contact), or previous contact means and log between a user and a subscriber, the control unit 140 can determine a contextual action and priority thereof.

Next, at step 703, the control unit 140 can analyze a status of a user device. Specifically, the control unit 140 can analyze, as a user device status, a battery state of the electronic device, a connection state (e.g., a mobile communication network, Bluetooth, Wi-Fi, etc.), an available sensor input value, and a user's rate system (e.g., remaining call minutes or messages, remaining data amount, etc.), and then determine a displayable contextual action item.

Next, at step 705, the control unit 140 can determine a contextual action through information about a highlight event, a relation between a user and a subscriber, and a user device status, analyzed respectively at step 501 in FIG. 5 and steps 701 and 703. Namely, a contextual action item to be displayed together with contact information can be determined according to a highlight event type, a relation between a user and a subscriber (i.e., related persons), a user device status, or a combination thereof

For example, as shown in Table 7, let's suppose that a user with no remaining call minute has information about a subscriber's phone number, email address and ChatON ID, that the user had a conversation with this subscriber by means of ChatON, and that this subscriber's birthday is approaching. First, since this highlight event corresponds to an approaching birthday, contact information can be displayed in the highlight area and allowable contextual action items can be a call and messaging. Further, since there is information about a subscriber's phone number, email address and ChatON ID, and since the user had a conversation with this subscriber by means of ChatON, allowable contextual action items determined using a combination of a highlight event and subscriber-related information can be a call, messaging, and a view of ChatON dialog window. Further, since the analysis of a user device status shows no remaining call minute, finally allowable contextual action items can be messaging and a view of ChatON dialog window except a call action item.

TABLE 7

| Highlight type | Related person(s) | User's status | Contextual action |
|---|---|---|---|
| Person having | Having following | No remaining | (if limited to 2) |
| approaching | information about | voice call | 1. ChatON |
| birthday | this person | minutes | 2. Messaging |
| Priority | Phone number | | because |
| actions for | Email address | | related person |
| this type: | ChatON ID | | can't receive |
| My story | Last 1-to-1 | | My Story |
| Messaging | conversation | | message |
| Call | happens in | | user has no voice |
| | ChatON | | call minutes |
| Person sending | | User cannot | 1. Call |
| a missed call | | connect to | 2. Message |
| or a new | | data network & | |
| message | | cannot access | |
| Assume last in- | | ChatON | |
| coming message | | | |
| was a ChatON | | | |
| message | | | |
| Priority action | | | |
| for this type: | | | |
| Reply back to | | | |
| this person the | | | |
| same way as | | | |
| the received | | | |

In another example, if a user who cannot connect to a network receives a missed call or a new message from a subscriber, and if the user had a conversation with this subscriber by means of ChatON, contact information can be displayed in the highlight area since a missed call or new message is received. Also, allowable contextual action items can be a call and messaging. Meanwhile, since the user had a ChatON conversation with this subscriber, a view of ChatON dialog window can be added to allowable contextual action items. However, since the analysis of a user device status shows a non-connectable state to the network, finally allowable contextual action items can be a call and messaging.

Returning to FIG. 5, at step 505, the control unit 140 can determine priority of the highlight event and/or the contextual action.

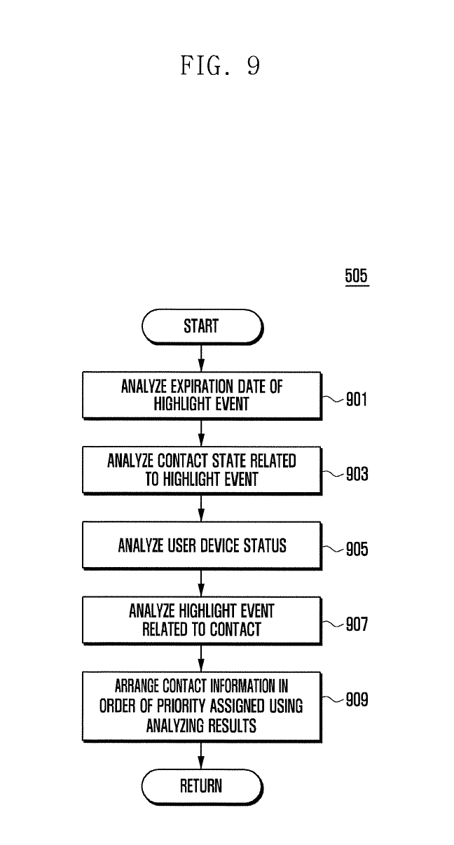

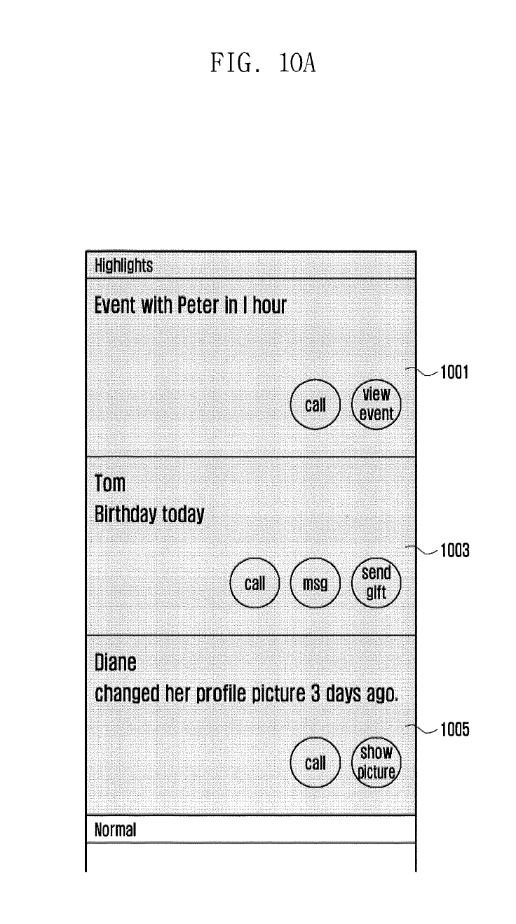

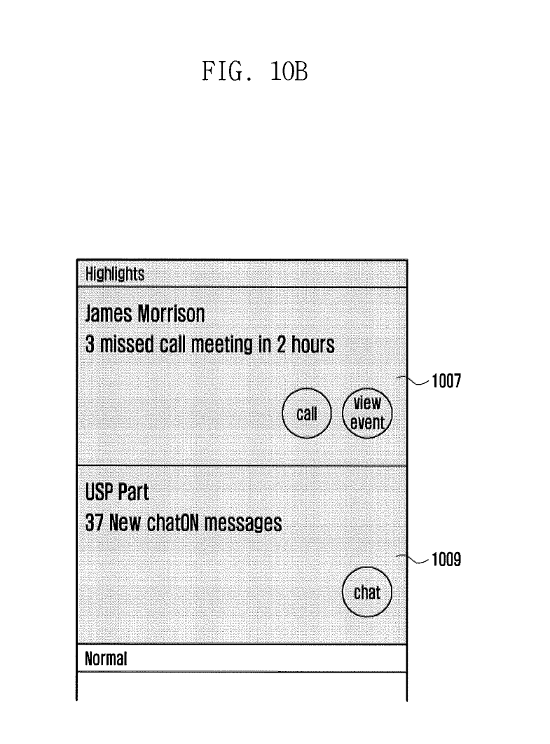

Now, step 505 will be described in detail with reference to FIGS. 9, 10A and 10B. FIG. 9 is a flow diagram illustrating a method for determining priorities of highlight events and contextual actions in accordance with embodiments of the present disclosure. FIGS. 10A and 10B are screenshots illustrating a method for determining priorities of highlight events and contextual actions in accordance with embodiments of the present disclosure.

The control unit 140 can assign a priority point to each of highlight events and/or contextual action items. Additionally, the control unit 140 can calculate the assigned priority points and display contact information in the highlight area in the order of higher priorities.

The control unit 140 can differently assign priority points to highlight events. Such points for assigned respectively to the highlight events can be predefined by a user and used as default values. Values of respective contextual action items can be equal to each other. The highest point is assigned to an important event and, based on this event, other points can be assigned in grades. Also, by summing up points assigned to contact information, contact information can be processed in the order of higher points.

For example, let's suppose that an approaching birthday event has one point, a reminder event has two points, and a call action item has one point. If the highlight area has both the first contact information corresponding to an approaching birthday event with a call action item and the second contact information corresponding to a reminder event with a call action item, the first contact information has total two points and the second contact information has total three points. Therefore, the second contact information can be processed preferentially.

Additionally, the control unit 140 can adjust or update a priority point of each highlight event and/or each contextual action, depending on an expiration date of a highlight event, a state of a subscriber related to a highlight event, a user device status, or a highlight event related to contact information. If highlight events are independent of each other, a highlight event having a higher sum of predefined points can be processed preferentially. If highlight events are grouped on the basis of related contact information, a highlight event having a higher sum of priority points assigned to contact information contained in each group can be processed preferentially. This preference processing can use a priority point of each action.

Referring to FIGS. 9, 10A and 10B, the control unit 140 can analyze an expiration date of a highlight event at step 901. Specifically, the control unit 140 can assign a higher priority point to an expiration-upcoming event or to contact information having much more highlight event types. Highlight events can have different expiration dates based on their predefined rules, and the control unit 140 can assign a higher priority point to a highlight event having an upcoming expiration date.

For example, the control unit 140 can assign a higher point to a today birthday event than to a birthday event in seven days, assign a higher point to an appointment event in one hour than to a tomorrow appointment event, and assign a higher point to an update event one day ago than to an update event three days ago. Namely, if there are an event in one hour as indicated by a reference numeral 1001 in FIG. 10A, a today birthday event as indicated by a reference numeral 1003, and an event of changing a profile photo three days ago as indicated by a reference numeral 1005, the control unit 140 can arrange these events in the order of an event in one hour, a today event, and an event three days ago.

Next, at step 903, the control unit 140 can analyze a state of a subscriber related to a highlight event. Specifically, each highlight event is related to one contact information or more, and the priority of a highlight event can be adjusted on the basis of a related subscriber's state and/or device status. Each highlight event as a predefined event is related to contact information, and such an event has contextual action item(s). Each action can be connected to a synchronous or asynchronous communication. When a subscriber is in a disabled or improper communication state, the priority point of a conflicting contextual action item and/or the priority of a highlight event can be adjusted lower. For example, if a subscriber's device is turned off, or if a subscriber is at night, the priority point can be assigned lower.

Next, at step 905, the control unit 140 can analyze a user device status. Namely, based on a user's status and/or a status of a user's device, the control unit 140 can change the priority of a highlight event. Specifically, each highlight event can have contextual action items, each of which is related to a user's status or a user device status. Such action items can include a call, messaging, a user's monthly plan, and the like. Since some contextual action items are predefined by a user, any conflict can happen between contextual action items and user's device. In this case, the priority point of a conflicting contextual action item and/or the priority of a highlight event can be adjusted lower. For example, if contact information displayed in the highlight area has a call action item as a contextual action, and if there is a meeting schedule event with a user in a subscriber's schedule, the control unit 140 can lower the priority point of contact information.

Next, at step 907, the control unit 140 can analyze a highlight event related to contact information. Specifically, highlight events of the same type can be grouped according to contact information, and a higher priority point can be assigned to a group having much more highlight event types. For example, as shown in FIG. 10B, a subscriber having two highlight event types as indicated by a reference numeral 1007 can be displayed preferentially rather than a subscriber having one highlight event type as indicated by a reference numeral 1009.

Next, at step 909, the control unit 140 can assign a priority point on the basis of analyzing results at steps 901 to 907 and arrange contact information related to a highlight event according to priority.

As discussed above, a highlight event type, subscriber-related information, and a user device status are used as criteria for determining an arrangement order in the highlight area and/or determining contextual action item(s). This is, however, exemplary only and not to be considered as a limitation of this disclosure.

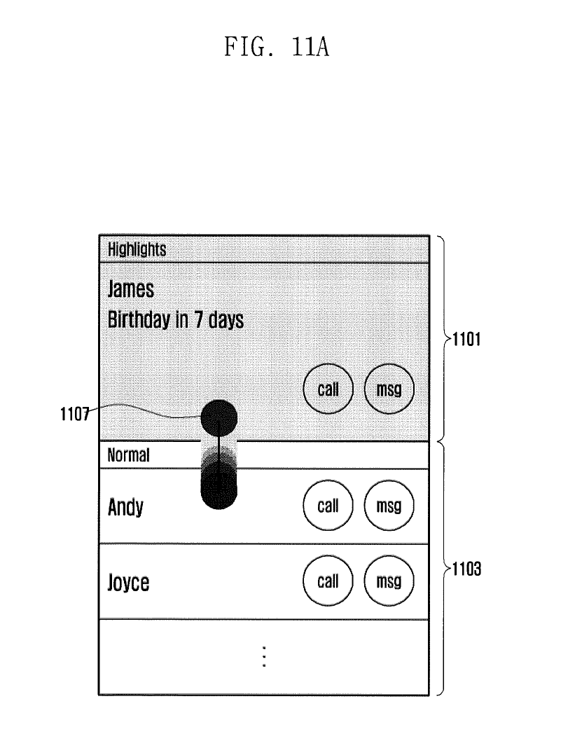

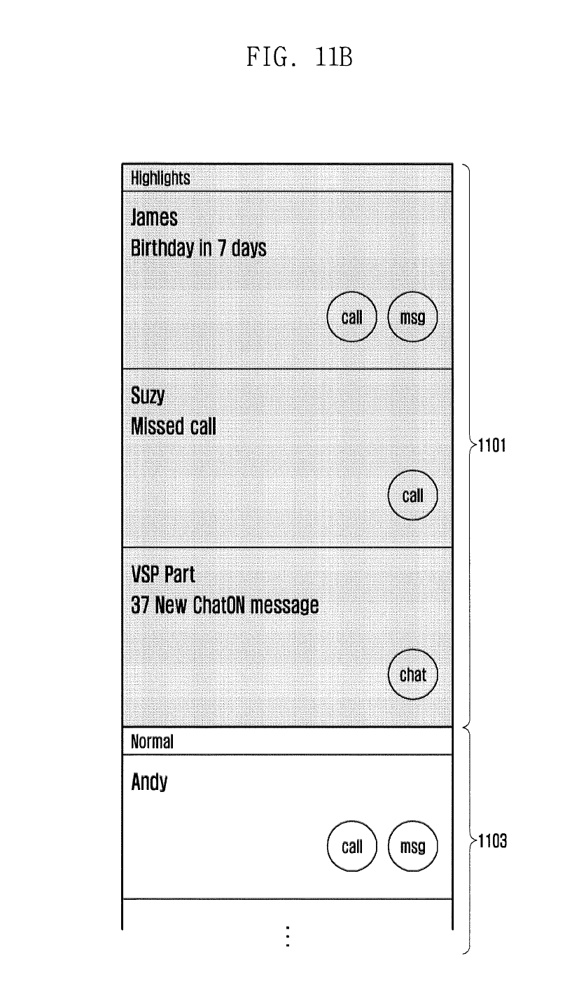

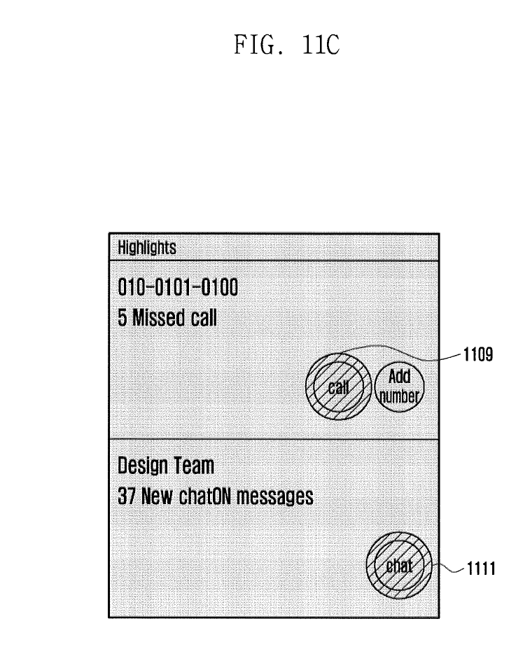

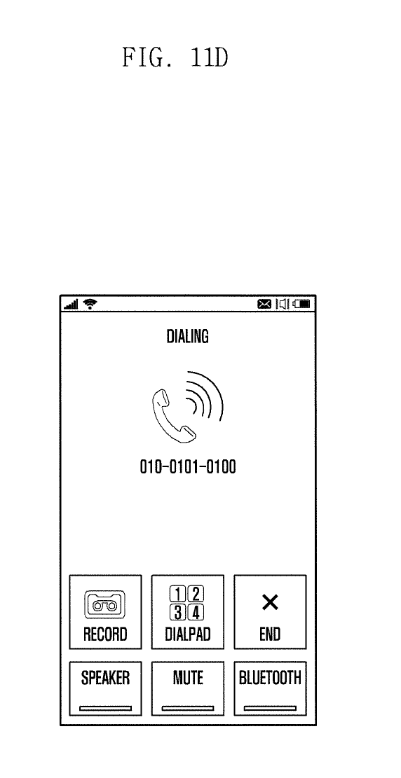

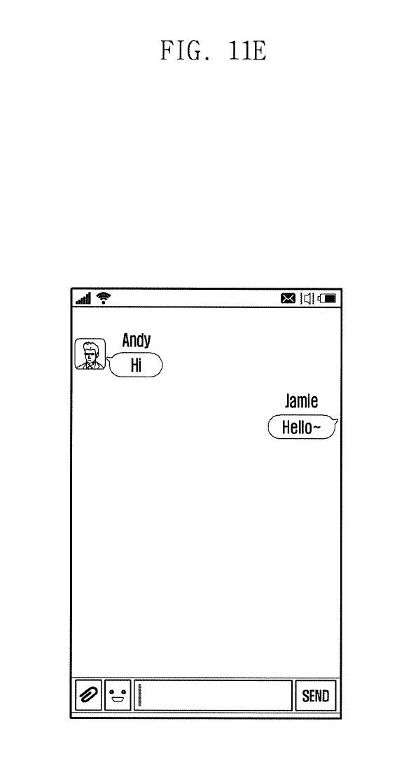

Returning to FIGS. 4A and 4B, remaining steps will be described in detail with reference to FIGS. 11A to 11E. FIGS. 11A to 11E are screenshots illustrating a method for controlling a contact list in an electronic device in accordance with embodiments of the present disclosure.

If no highlight event occurs at step 403, the control unit 140 can store log information about an event at step 407.

If no event occurs at step 401, the control unit 140 can determine at step 409 whether to display a contact list. This determination can be performed together with the execution of a contact application and/or a call application. If the execution of the contact application and/or the call application happens, the control unit 140 can detect it at step 409 and control at step 411 the display unit 131 to display a contact list as shown in FIG. 11A. This contact list can be displayed by being divided into a highlight area 1101 and a normal region 1103. The contact list can contain therein a phonebook stored in the electronic device and contact information synchronized with a web server. The highlight area indicates an area used to display notable contacts, i.e., contacts being worthy of a user's notice, and the normal area indicates an area used to display contact information registered by a user in the contact list. Additionally, the contact list can have contact information and contextual action items for performing particular functions (e.g., a text message, a conference call, an email sending, etc.) related to subscribers. These contextual action items can be determined according to a highlight event, subscriber-related information, a user device status, or a combination thereof, and displayed together with contact information as indicated by a reference numeral 1105 in FIG. 11A.

At step 413, the control unit 140 can determine whether a gesture is detected from the highlight area of the contact list displayed in the display unit 131. This gesture can be a touch-based gesture such as a drag or a flick as indicated by a reference numeral 1107 in FIG. 11 A. When this gesture occurs at the highlight area, the control unit 140 detects it at step 413 and control at step 415 the display unit 131 to display the contact list of the highlight area in a full mode. Each of the highlight area and the normal area can be formed of a single layer. This is, however, exemplary only and not to be considered as a limitation. When a gesture is detected from the highlight area, the control unit 140 can control the display unit 131 to overlay hidden contact information of the highlight area on the normal area. At this time, the control unit 140 can further control the display unit 131 to display contact information of the normal area below the extended contact list of the highlight area.

As discussed above, highlight events to be displayed in the highlight area can include contact information about an approaching birthday, contact information about a missed call or a new message, contact information about an upcoming schedule, contact information about a received invitation message, contact information about a new-created mutual relationship, contact information about a frequent unknown contact, contact information about a reminder, an updated group, and contact information having an updated profile. These nine events are exemplary only and not to be considered as a limitation of this disclosure.

Next, at step 417, the control unit 140 can determine whether a touch input is detected from a contextual action item in the highlight area. This contextual action item (or icon) can include, for example, a call action item, a message transmission action item, an email transmission action item, a schedule action item, a chatting action item, and the like. When a touch input occurs at the contextual action item, the control unit 140 can detect it at step 417 and perform at step 419 a particular function corresponding to the touched item.

For example, as shown in FIG. 11C, the control unit 140 can detect a touch input from a contextual action item related to contact information displayed in the highlight area. If a touch input occurs at a ‘call’ item 1109, the control unit 140 can perform a call function by switching to a call application as shown in FIG. 11D. If a touch input occurs at a ‘chat’ item 1111, the control unit 140 can control the display unit 131 to display a dialog window by switching to a ChatON application as shown in FIG. 11E.

Once any contact operation is performed according to contact information registered in the highlight area, the control unit 140 can delete such contact information from the highlight area. Namely, if a contact function is performed for a missed call, the control unit 140 can remove contact information about the missed call from the highlight area. In case there is schedule information about an event such as a birthday or an appointment, contact information about such a highlight event can be removed from the highlight area when the schedule (date or time) expires. Namely, even though a contact function has been performed already, contact information having schedule information can remain in the highlight area if the schedule does not expire. Contact information in the highlight area can be removed by a user.

If no gesture occurs at the highlight area at step 413, the control unit 140 can control at step 421 the display unit 131 to display contact information of the normal area. Such contact information of the normal area can be scrolled with contact information of the highlight area fixed. Alternatively, contact information of the normal area can be displayed together with non-fixed contact information of the highlight area.

Next, at step 423, the control unit 140 can detect the termination of the contact application and/or the call application. If no termination is detected, the control unit 140 can return to step 401.

As fully discussed hereinbefore, the electronic device according to various embodiments of this disclosure can intuitively offer notable contact information by arranging event-occurring contact information in the highlight area in the order of priority when the contact application is executed.

Further, this disclosure may allow a function related to contact information to be easily performed through an event and a contextual action item displayed in the highlight area.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for controlling a contact list in an electronic device, the method comprising:
when an event to be highlighted occurs, scheduling contact information related to the highlight event into a highlight area;
displaying a contact list comprising the highlight area containing the contact information related to the highlight event, and a normal area containing normal contact information,
wherein the contact information related to the highlight event includes one or more contextual actions; and
when one of the contextual actions is selected, executing the selected contextual action.

2. The method of claim 1, wherein the highlight event includes at least one of a subscriber's birthday event, an unread communication event, and a schedule reminder event.

3. The method of claim 2, wherein the unread communication event includes at least one of a missed call, an SMS (Short Message Service), an email, and an SNS (Social Network Service).

4. The method of claim 1, wherein scheduling the contact information includes:
analyzing the highlight event;
determining an available contextual action of a subscriber related to the highlight event; and
determining priority of the contact information according to the highlight event and the determined contextual action.

5. The method of claim 4, wherein determining the contextual action includes:
analyzing a relation between a user and the subscriber related to the event;
analyzing a user device status; and
determining the contextual action on the basis of the event, the analyzed relation between the user and the subscriber, and the analyzed user device status.

6. The method of claim 4, wherein determining the priority includes:
analyzing an expiration date of the highlight event;
analyzing a status of the subscriber related to the highlight event;
analyzing a user device status;
analyzing the highlight event related to the subscriber; and
arranging the contact information in the order of a priority point assigned using analyzing results.

7. The method of claim 1, wherein displaying the contact list includes:
when a gesture is detected from the highlight area, displaying the contact list of the highlight area in a full mode.

8. The method of claim 7, wherein each of the highlight area and the normal area is formed of a single layer, and wherein hidden contact information of the highlight area is overlaid on the normal area in response to a detection of a gesture from the highlight area.

9. The method of claim 7, wherein the contact information in the highlight area is displayed distinguishably from the contact information in the normal area by means of color, shade, and/or other graphical effect.

10. The method of claim 1, wherein the contact list includes phonebook contact information and synchronization contact information synchronized with a web server.

11. The method of claim 1, wherein the contextual action includes at least one of a call, a message transmission, an email transmission, a reply, a detail view of contact information, a contact save, and a sharing.

12. An apparatus for controlling a contact list, the apparatus comprising:
a display unit configured to display a contact list comprising a highlight area and a normal area; and
a control unit configured to:
when an highlight event occurs, schedule contact information related to the highlight event into the highlight area, and control the display unit to distinguishably display the highlight area containing the contact information related to the highlight event and the normal area containing normal contact information, wherein the contact information related to the event includes one or more contextual actions, and wherein when one of the contextual actions is selected, the control unit is further configured to execute the selected contextual action.

13. The apparatus of claim 12, wherein the control unit is further configured to control the display unit to display the contact information related to the highlight event in the highlight area when a subscriber's birthday event, an unread communication event, or a schedule reminder event occurs as the event.

14. The apparatus of claim 12, wherein the control unit is further configured to analyze the event, to determine an available contextual action of a subscriber related to the event, and to determine priority of the contact information according to the event and the determined contextual action.

15. The apparatus of claim 14, wherein the control unit is further configured to determine the contextual action by analyzing a relation between a user and the subscriber related to the event and by analyzing a user device status.

16. The apparatus of claim 14, wherein the control unit is further configured to assign a priority point by analyzing an expiration date of the event, a state of the subscriber related to the event, a user device status, and the event related to the subscriber, and to arrange the contact information in the order of the priority point.

17. The apparatus of claim 12, wherein the control unit is further configured to control the display unit, when a gesture is detected from the highlight area, to display the contact list of the highlight area in a full mode and to overlay hidden contact information of the highlight area on the normal area

18. The apparatus of claim 12, wherein the control unit is further configured to display distinguishably the contact information in the highlight area and in the normal area by means of color, shade, and/or other graphical effect.

19. The apparatus of claim 12, wherein the contact list includes phonebook contact information and synchronization contact information synchronized with a web server.

20. The apparatus of claim 12, wherein the contextual action includes at least one of a call, a message transmission, an email transmission, a reply, a detail view of contact information, a contact save, and a sharing.
